(19) United States
(12) Patent Application Publication
(10) Pub. No.: US 2017/0283176 A1
(43) Pub. Date: Oct. 5, 2017

(54) APPARATUS FOR CONVEYING PRODUCTS

(71) Applicant: PULSAR S.R.L., Castel Maggiore (bologna) (IT)

(72) Inventor: Massimo FRANZAROLI, CASTEL MAGGIORE (BOLOGNA) (IT)

(21) Appl. No.: 15/508,733

(22) PCT Filed: Sep. 1, 2015
(86) PCT No.: PCT/IB2015/056636

§ 371 Date: Mar. 3, 2017

(30) Foreign Application Priority Data
Sep. 3, 2014 (IT) BO2014U000074

(51) Int. Cl. B65G 21/06; B65G 21/20; B65G 21/10; B65G 17/08; B65G 21/22

(52) U.S. Cl. CPC B65G 21/06; B65G 17/086; B65G 21/22; B65G 21/10; B65G 21/2072; B65G 2207/30; B65G 2201/0232

(57) ABSTRACT

Described is an apparatus for conveying a product, such as articles of the tissue sector in the form of rolls or packages. The apparatus includes a unit for supporting corresponding unit for conveying the product, in particular following a respective path between a respective upstream end and a respective downstream end; More specifically, the conveying unit have one or a plurality of conveyor belts, especially of the type with links articulated to each other, preferably through corresponding articulation pins; the apparatus has a plurality of separate modules, each of which is designed to define a respective conveying section or stretch or longitudinal extension of the apparatus, the respective modules can be associated with each other and include a plurality of component units of the conveying section or stretch which are in a pre-assembled condition with each other.

### TECHNICAL FIELD

This invention relates to an apparatus for conveying a product.

### BACKGROUND ART

There are prior art apparatuses for conveying articles of the tissue sector, for example in the form of rolls of toilet paper and/or kitchen paper, the apparatuses being set up or installed entirely at the plant in which they are to operate, installing, one at a time, the longitudinal elements and, if any, the traversal elements, defining the supporting structure of the line, on respective uprights with feet resting on the ground, that is supported hanging from above, and then arranged on this structure are the guides for the conveyor belt, the guides for the product conveyed, and then the drive means are installed, comprising the heads of the drive wheel and the electrical or other types of drive mechanisms, and lastly the electrical cables are installed, also for respective sensor means, as well as for connection to the computerised control means of the apparatus, all through complex and laborious operations. This results in times and costs for setting up and assembly which are extremely high.

This problem is equally felt when it is necessary to modify the conveying paths inside corresponding plants, as it is necessary to carry out the almost complete dismantling of the entire line, installed previously, and installation in a different position, operating as described above.

Moreover, in several sectors, and in particular in the tissue sector, which processes paper material, a large quantity of waste and/or dust is produced, which creates problems to various components of the conveying apparatuses, which are also particularly difficult to clean.

A further problem of prior art conveying apparatuses regards the lengthy times necessary to perform maintenance or repairs, in particular to mechanical and moving parts, such as drive and return wheels, electric motors and so on.

The assembly, cleaning, repairs and maintenance operations translate into the planning of plant stoppages for maintenance lasting several hours, resulting in considerable economic losses for the production companies.

A further need felt by operators is that of having a conveying apparatus which adapts to the product conveyed, in particular to the size of the product, especially through operations which are as fast and easy as possible.

Another need felt is that of having a conveying apparatus which allows a high accessibility to the product conveyed, that is, which does not have excessive dimensions for the operators responsible for supervision of the conveying apparatus and/or which allows a good vision of the product, for example to allow an easy and effective control of the product conveyed.

### AIM OF THE INVENTION

This invention therefore proposes a new solution as an alternative to the solutions known up to now and, more specifically, proposes to overcome one or more of the above mentioned drawbacks and/or problems and/or to meet one or more of the needs felt in the trade or inferable from the above.

According to a particularly advantageous aspect, an apparatus is provided for conveying a product, the product preferably being in the form of respective articles, in particular in the form of articles of the tissue sector, preferably made of paper or other material, such as fabric or non-woven fabric, the articles being preferably in the form of rolls, packages, in particular packs or packets, or respective containers, in particular for toilet paper, kitchen paper, napkins, tissues, serviettes, towels, bed sheets, and other, or in the form of rolls of material which can be used in the kitchen, such as aluminium foil, plastic film or similar; the apparatus comprising means for supporting the corresponding means for transporting the product, in particular having one or a plurality of conveyor belts, especially of the type with links which are articulated to each other, preferably by corresponding articulation pins; characterised in that the apparatus has a plurality of separate modules each of which is designed to define a respective conveying section or stretch or longitudinal extension of the apparatus, the respective modules being associable with each other and comprising a plurality of component means of the conveying section or stretch which are in a pre-assembled condition on the respective module.

In this way, it is possible to pre-assemble the module in the factory or at the bench, if necessary keeping it in the store prior to use, and install it when necessary, associating it with corresponding modules, to obtain, in a quick and easy fashion, a corresponding conveying apparatus. All of this with a considerable saving in time and production costs.

### BRIEF DESCRIPTION OF THE DRAWINGS

This and other innovative aspects of this apparatus and module are set out in the appended claims and its technical features and advantages are apparent from the detailed description which follows of non-limiting example embodiments of it with reference to the accompanying drawings, in which:

FIG. 1 is a schematic top plan view of a preferred embodiment of the apparatus according to this invention;

FIGS. 2A to 2G are corresponding schematic top plan views of a plurality of modules according to this invention;

FIG. 3A is a side view of a longitudinal module, in particular rectilinear, according to a corresponding preferred embodiment of the module according to this invention;

FIG. 3B is a front view of the preferred embodiment of the module of FIG. 3A;

FIG. 3C is a top plan view of the preferred embodiment of the module of FIGS. 3A and 3B;

FIG. 3D is an exploded perspective view of the preferred embodiment of the module illustrated in FIGS. 3A to 3C;

FIG. 3E is a perspective view of a preferred embodiment of a curvilinear module for a curved stretch in this embodiment of the conveying apparatus;

FIG. 4A is a perspective view showing a preferred embodiment of respective mutual connecting means between longitudinal elements and/or modules of the conveying apparatus according to this invention;

FIG. 4B is a longitudinal cross section showing in particular the preferred embodiment of the mutual connecting means according to this invention;

FIG. 4C is a transversal cross section through line C-C of FIG. 4 showing in particular the preferred embodiment of the mutual connecting means according to this invention;

FIG. 4D is a schematic transversal cross section through line D-D of FIG. 4B, showing in particular the preferred embodiment of the mutual connecting means according to this invention;

FIG. 5A is a perspective view of a preferred embodiment of the longitudinal supporting element of this conveying apparatus or of the respective module;

FIG. 5B is a side view of the preferred embodiment of the longitudinal supporting element;

FIG. 5C is a perspective view of a detail relative to an end of the preferred embodiment of the longitudinal supporting element;

FIG. 5D is a front view of the preferred embodiment of the longitudinal supporting element according to this invention;

FIG. 5E is an exploded perspective view of the preferred embodiment of the longitudinal supporting element according to this invention;

FIG. 6A is a perspective view of a preferred embodiment of the conveying apparatus or corresponding module, showing in particular a preferred embodiment of the guide means for the product conveyed;

FIGS. 6B to 6D are front views of the guide means of the product, showing in particular various operating positions of these obtained through this preferred embodiment of the means for adjusting the track or the distance between the guides of the product;

FIG. 6E is an exploded perspective view of the preferred embodiment of the means for adjusting the mutual distance or track of the product guide means;

FIG. 7A is a perspective view of a further preferred embodiment of the supporting means of this conveying apparatus or respective module;

FIG. 7B is a front view of the making of the supporting means shown in the previous FIG. 7A;

FIG. 7C is a partial cross sectional view showing in particular a preferred embodiment of the means for connecting the perpendicular supporting means or uprights to the supporting means in the conveying plane;

FIGS. 7D to 7G are perspective views of a first and second preferred embodiment of the means for connecting the perpendicular supporting means or uprights to the supporting means in the conveying plane;

FIG. 8A is a perspective view, with relative enlarged detail, of a portion of the conveying apparatus showing in particular a preferred embodiment of the means for housing corresponding connecting ducts, cabling and the like, shown in the open condition;

FIG. 8B is a transversal cross section, with related enlarged details, of this conveyor apparatus or relative module, showing in particular the channels or lateral means for housing corresponding connecting ducts, cabling and the like;

FIG. 9A is a side view of a preferred embodiment of the end portion which can be lifted of this conveying apparatus or module;

FIG. 9B is a side view of a preferred embodiment of the wheel-carrying head, in particular the drive wheel, which can be used in the end portion of this conveying apparatus or module;

FIG. 9C is a perspective view of the wheel-carrying head in the condition of detachment from the corresponding longitudinal supporting means;

FIG. 9D is a perspective view of the various steps of detachment of the wheel-carrying head and the corresponding means for supporting the conveyor belt; and

FIG. 9E is a horizontal cross section, in particular relative to a zone or module for transfer of the products between different portions upstream or downstream of the conveying apparatus.

### DETAILED DESCRIPTION OF PREFERRED EMBODIMENTS OF THE INVENTION

The accompanying drawings show a preferred embodiment 10 of the apparatus for conveying a product.

The product conveyed consists, in particular, of respective articles, which are transported aligned with each other in the close-together condition or in contact with each other, that is, in a condition spaced longitudinally or along the direction of extension of the conveying apparatus.

The articles are, in particular, in the form of articles produced in the so-called “tissue” sector, preferably made of paper material, such as thin and soft paper, which is lightweight and made with cellulose or other natural and/or synthetic fibres, or from another material, such as fabric or non-woven fabric.

The articles are preferably in the form of rolls, packages, in particular packs or packets, or respective containers, in particular for toilet paper, kitchen paper, napkins, tissues, serviettes, towels, bed sheets, and other, or in the form of rolls of material which can be used in the kitchen, such as aluminium foil, plastic film or similar.

The conveying apparatus is in any case preferably located between an upstream machine, which makes the articles, for example cutting them from respective logs, or elongate rolled bodies, and one or more downstream machines which package the articles, in particular groups of the articles in corresponding wrapping, for example in a corresponding plastic film, and in any case for making a corresponding pack of articles.

It will be understood, however, that whilst the use in the tissue sector is particularly preferred, this apparatus is, however, also designed to convey other types of articles or products, for example in the form of containers, preferably for liquid or semi-liquid products, in particular food products, that is, rolls of material which can be used in the kitchen, such as aluminium foil, film plastic or similar materials.

As illustrated, the conveying apparatus 10 comprises means 12 for supporting corresponding means 14 for conveying the product, in particular following a respective path extending between a respective upstream end 101 and a respective downstream end 102 of the apparatus.

As illustrated, this conveying apparatus has a plurality, in this embodiment four, lines for conveying the product, designed to convey respective rows of articles aligned with each other. It is also possible to imagine making an apparatus with various lines, if necessary arranged on two or more levels or supporting planes, as described in more detail below, that is, using a single line or conveyor belt for respective articles.

This apparatus comprises means 14 for conveying the product which are designed to include one or a plurality of conveyor belts 141, especially of the type with links 142. which are articulated to each other, preferably through corresponding articulation pins, which however are not illustrated in detail in the accompanying drawings.

More specifically, each link might be in the form of links designed to support transversally a single product, or in the form of widened links to support products with large dimensions, at least in width, or various products alongside each other.

The conveyor belt 141, by way of example, could be as described in international patent application no. WO 2012/001538 in the name of the same Applicant, which is incorporated herein by reference.

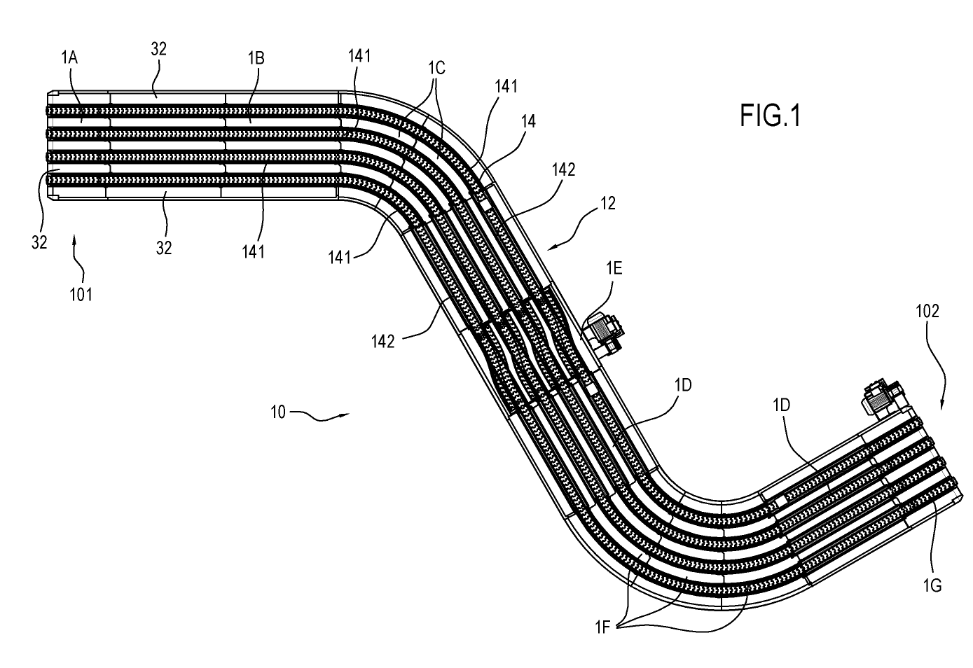

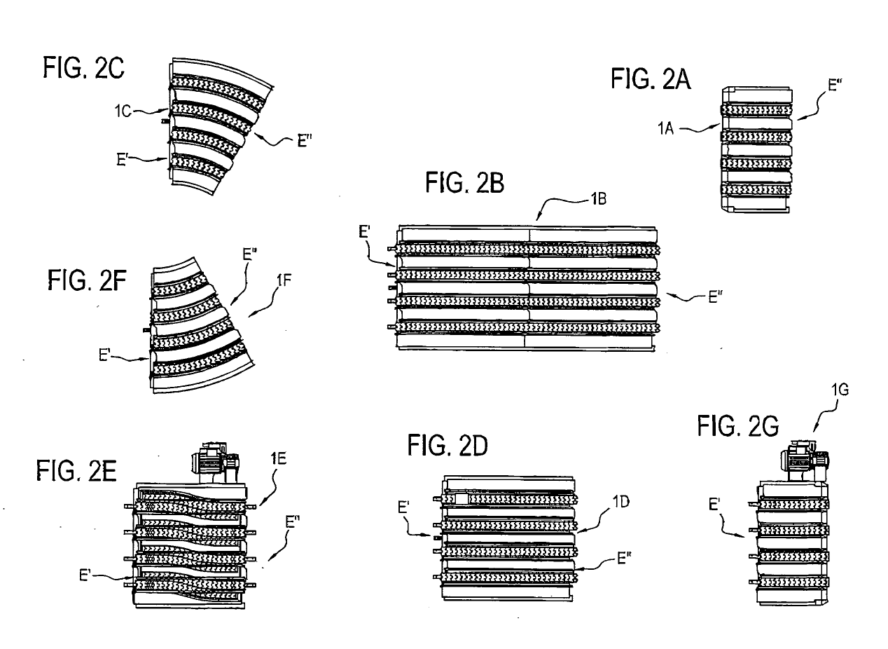

As may be inferred in particular from FIGS. 1 and 2A to 2G, advantageously, the apparatus 10 comprises a plurality of separate modules, respectively 1A, 1B, 1C, 1D, 1E, 1F, 1G, each of which is designed to define a respective conveying section, or stretch, or longitudinal extension, of the conveying apparatus.

More specifically, the respective modules are, conveniently, associable with each other and comprise a plurality of component means of the conveying section, or stretch, which are pre-assembled on the respective module.

In this way, it is possible to pre-assemble the respective module in the factory or at the bench, if necessary keeping it in the store prior to use, and install it in a quick and easy fashion, together with other modules, to obtain the desired or required conveying apparatus, all of this with considerable savings in time and production costs.

As illustrated, in particular, respective module 1B or 1D is provided which is designed to define a respective section, or stretch, of the conveying apparatus which extends in a rectilinear fashion. More specifically, the rectilinear module is in the form of a first preferred embodiment of the rectilinear module 1D which has a respective and predetermined length, that is, it is in the form of a second preferred embodiment of the rectilinear module 1B, which has a length twice that of the first module.

Advantageously, there is also a module which is designed to define a respective section, or stretch, of the conveying apparatus which extends in a curvilinear fashion, especially extending along a respective circumferential stretch, and which, specifically, is designed to curve along the product conveying plane in a right-hand direction, the embodiment of module 1C, which is illustrated in FIG. 2C, that is to say, which is designed to curve along the product conveying plane in a left-hand direction, the embodiment of module 1F, which is illustrated in FIG. 2F.

Advantageously, the respective curvilinear module 1C and 1F extends along the direction of extension of the apparatus for a predetermined angular stretch, defined between the respective ends extending radially of the same module, the angular stretch being preferably an angular extent equal to 30°, in this way it is possible to associate with each other different curvilinear modules and thus obtain a curved stretch of the conveying apparatus of desired angular extent and a multiple of the predetermined angular extent of the individual module, that is, a multiple of 30°, thus obtaining curves with an angular extent of 60° or 90°, as illustrated in FIG. 1, or even angular extents greater than this.

However, it will be understood that curvilinear modules whose angular extent is different from 30° are also imaginable and more specifically a module may be provided, curving to the right or to the left, in the product conveying plane, which has an angular extent, in the direction of extension of the device, which is equal to 45°.

It will be understood that it is also possible to make corresponding modules which are designed to curve along a perpendicular direction for making corresponding conveying stretches extending perpendicularly, especially for transporting the products at conveying levels which are located at different heights from each other.

Further advantageously, there is a respective module 1E designed to define a respective section, or stretch, of the conveying apparatus, which defines means for transferring, or passage, of the product between an upstream portion and a downstream portion of the means for conveying the product of the conveying apparatus.

Further advantageously, there is a respective module designed to define a respective section, or stretch, of the conveying apparatus which defines, or has, means for driving the means of transport of the product, in particular defining, or comprising, a respective end drive head 1G, that is, defining, or comprising, a respective drive head 1E, at a section, or stretch, for transferring the product.

Further advantageously, there is a respective module 1C designed to define a respective section, or stretch, of the conveying apparatus which defines means for driving the means of transport of the product, that is, which defines a respective end return head of the conveying apparatus.

Advantageously, the respective modules 1A, 1B, 1C, 1D, 1E, 1F, 1G can be connected directly to each other, in particular being mutually connectable at the respective and opposite ends E′ and/or E″, respectively upstream and/or downstream according to direction of extension of the conveying apparatus.

Advantageously, in use, the ends E′, E″ facing each other, of the modules connected to each another, engage one against the other.

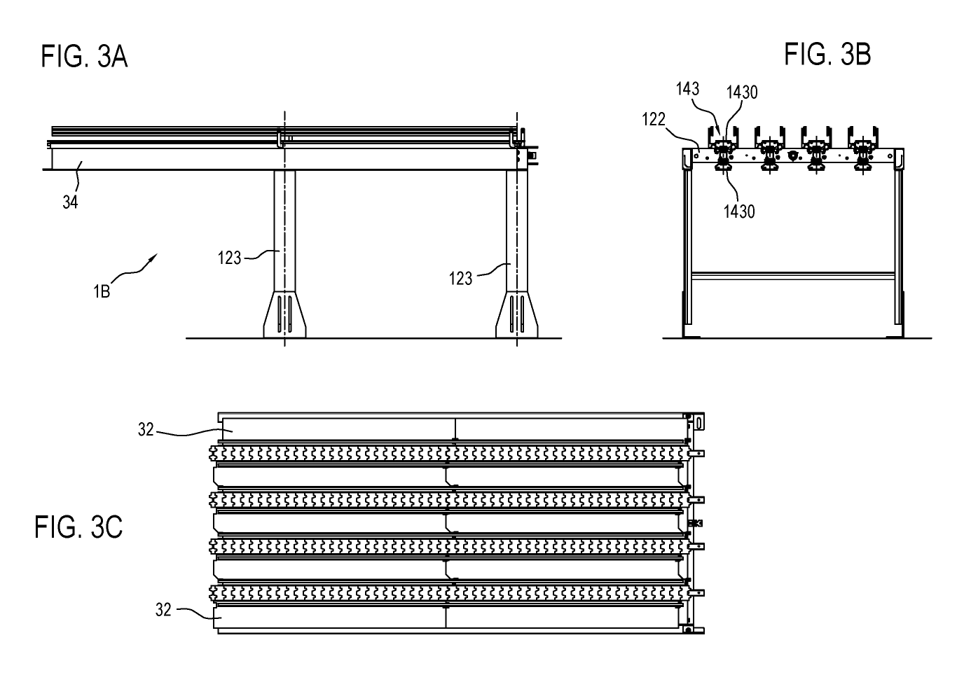

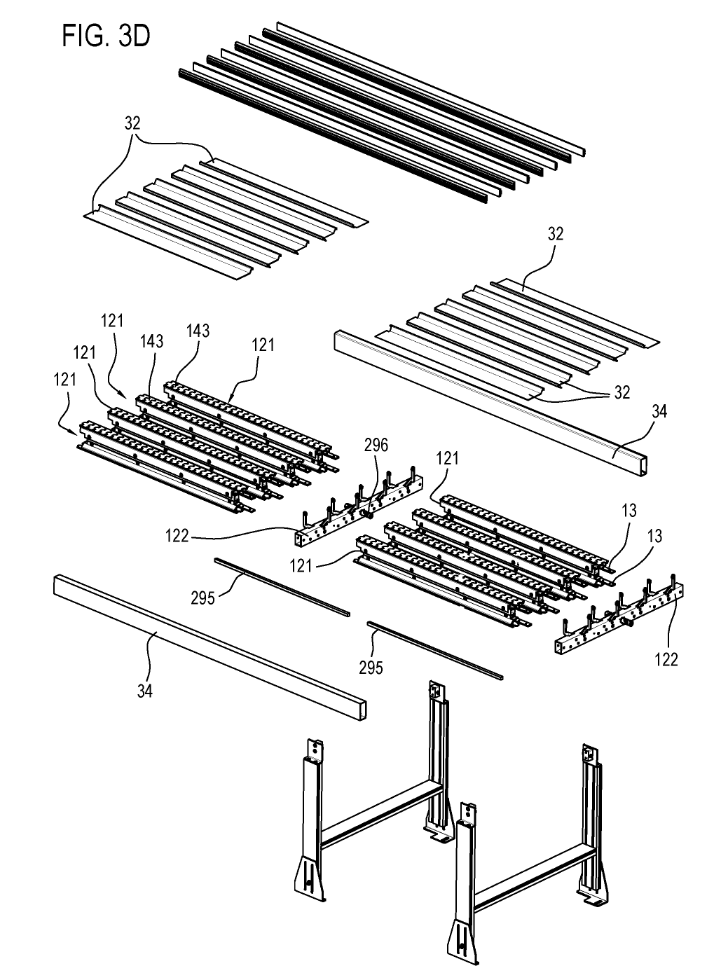

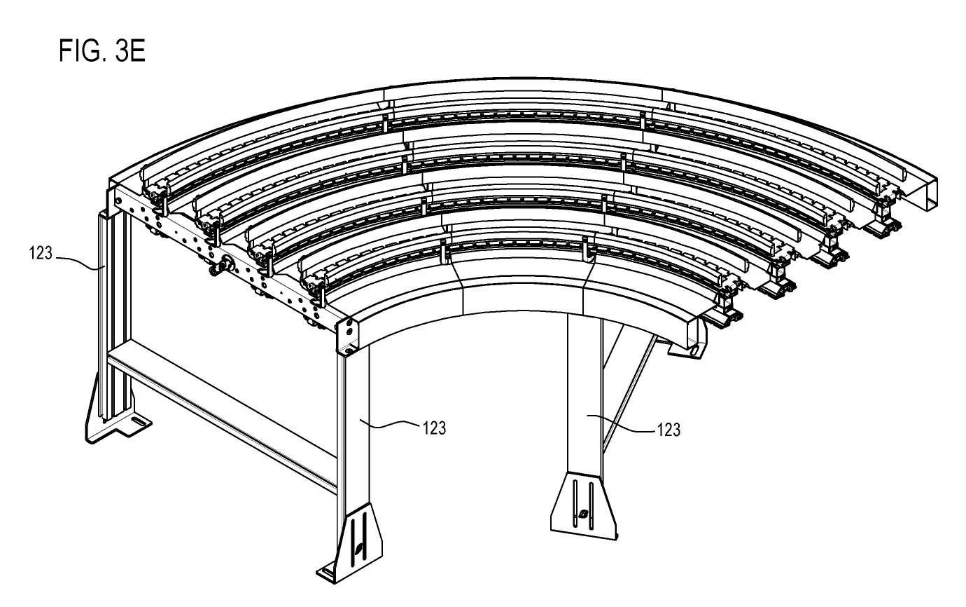

It may be inferred from FIGS. 3A to 3E, which show in particular the respective rectilinear module with double the length 1B, and from FIG. 3E, which shows a corresponding curvilinear module, how the component means of the respective module comprise, advantageously, a respective portion 143, in particular an upper branch 1430 and/or a lower branch 1430, of a conveyor belt 141, in particular of the type with articulated links 142.

Moreover, as may be inferred, the apparatus comprises supporting means 12, in particular defining corresponding component means of the respective module, the supporting means 12 comprising one or a plurality of longitudinal supporting elements 121.

Advantageously, as illustrated, the respective longitudinal supporting element 121 is designed to support a corresponding longitudinal section of a respective conveyor belt 141, in particular an upper branch and a lower branch 1430, 1430, of a respective conveyor belt, especially respective upper and lower portions of a conveyor of the type with articulated links.

As illustrated, the longitudinal supporting elements 121, of the respective module or conveying apparatus, are transversally spaced from each other and extend preferably parallel to or in any case equidistant from each other.

Advantageously, according to another aspect, the apparatus comprises supporting means 12, in particular defining respective component means of the respective module, the supporting means comprising at least one transversal support element 122 or, as illustrated in FIGS. 3A to 3D, a first and a second transversal supporting element 122, 122.

As illustrated, preferably, the respective transversal supporting element 122 extends at right angles to the respective longitudinal supporting element 121, that is to say, with reference to the modules or sections of the apparatus which define a corresponding curvilinear path, the respective transversal supporting element extending radially, in particular with the corresponding longitudinal supporting element extending circumferentially.

In practice, the respective longitudinal supporting elements 121, that is, the respective modules, extend aligned with each other to define the path of the conveying apparatus and, in particular, in relation to the module for transfer of the product 1E, with corresponding end portions of the longitudinal supporting elements which are which placed alongside each other, as will be described in more detail below.

In practice, the respective transversal supporting element 122 is positioned between corresponding longitudinal supporting elements 121, 121, in particular between corresponding longitudinal supporting elements 121, 121 which are longitudinally aligned with each other, that is, aligned with each other along the direction of extension of the apparatus.

More specifically, as illustrated, the respective transversal supporting element 122 extends substantially coplanar to the corresponding longitudinal supporting element 121.

Moreover, as illustrated, the respective transversal supporting element 122 is at the end of the respective longitudinal supporting element, that is, of the respective module of the conveying apparatus.

In practice, advantageously, the apparatus comprises supporting means 12, in particular defining respective component means of the respective module, the supporting means 12 defining a corresponding supporting frame 121, 122, which extends to define a respective plane of extension of the conveying apparatus, especially extending, as illustrated, horizontally. In practice, the longitudinal and transversal elements 121, 122 define the load-bearing framework of a horizontal frame, extending through the plane or direction of extension of the conveying apparatus.

In practice, advantageously, the respective module comprises a supporting body which has at least one transversal structural element 122 and one or more longitudinal structural elements 121, rectilinear or curvilinear, and preferably a number of longitudinal supporting elements, which correspond to the number of conveyor belts, or transport lines, 141 of the conveying apparatus.

With such a configuration of the structural elements, a respective module is obtained which has a basic structure with a relatively low weight.

In the respective stretch of the apparatus, or in the respective module, when this comprises more than one transversal supporting element 122 the transversal supporting elements 122, 122 are longitudinally or angularly spaced from each other, in particular being parallel, that is, radially converging, with each other.

Advantageously, the respective transversal supporting element 122 supports the longitudinal supporting elements 121.

In effect, as illustrated, the supporting means 12 comprise perpendicular supporting means 123, in particular defining respective component means of the respective module, the perpendicular supporting means being preferably in the form of respective means or uprights resting on the ground, that is, ending with respective feet for fixing to the ground.

Advantageously, the respective transversal supporting element 122 is supported by corresponding perpendicular supporting means, or uprights, 123, which are fixed at the lateral ends of the respective transversal supporting element.

As illustrated, the apparatus, in particular the respective module, comprises means 16 for guiding the means of transport of the apparatus, in particular of the respective conveyor belt 141, the guide means 16 of the transport means defining respective component means in the pre-assembled condition of the corresponding module.

In practice, there are a plurality of means for guiding respective conveyor belts alongside each other.

Advantageously, the respective means 16 for guiding the transport means of the apparatus, in particular of a corresponding module, comprise first guide means 16 for a respective outward and/or upper branch of the conveyor belt and second guide means 16 for a corresponding return and/or lower branch of the conveyor belt 141.

Advantageously, the means 16 for guiding the transport means of the apparatus or of the module are supported by a respective longitudinal supporting element 121, on which, preferably, the respective conveyor belt slides.

As illustrated, advantageously, the respective transversal supporting element 122 is in the form of a tubular body, in particular with a quadrangular cross section, preferably rectangular in shape and especially, as will be explained in more detail below, designed to support, preferably designed to house, inside it, means for adjusting the track, or space available for the passage or forward movement of the product, defined by the transversal distance between the guides of the product conveyed on the respective conveyor belt.

In practice, the means for adjusting the track defined by the means for guiding the product on the transport means are housed inside a corresponding container body, preferably a closed container body, which is, in particular, defined by the transversal supporting element 122.

This advantageously avoids the soiling of the adjustment mechanism with waste or dust.

As illustrated, the profile, or section, of the transversal supporting element 122 is more elongate perpendicularly to the transport plane of the product, so as to define a corresponding resistant section, with a greater bending along an axis perpendicular to the extension of the conveying or transport plane of the product.

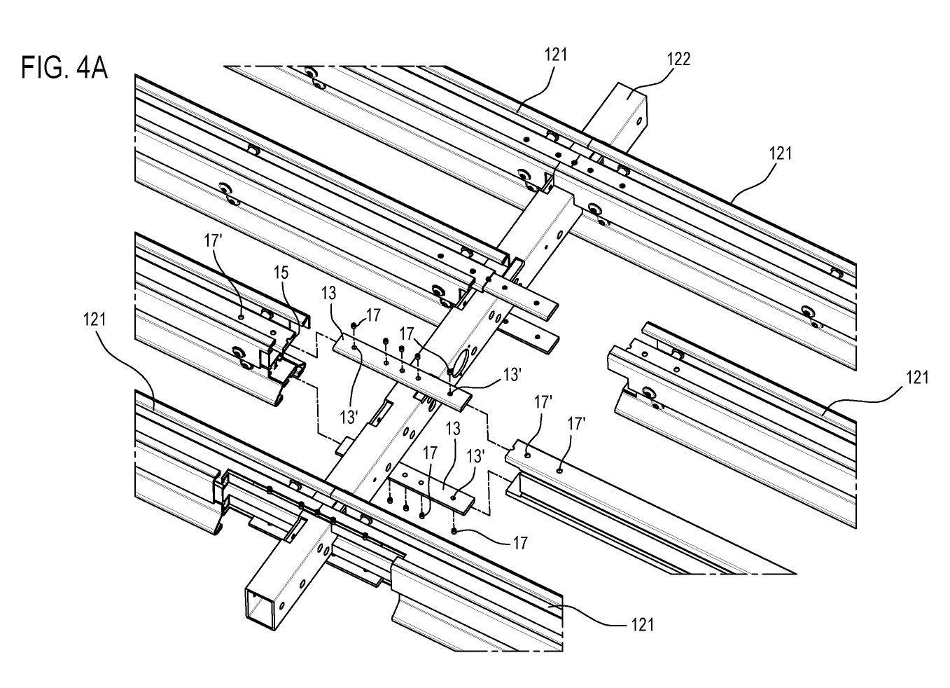

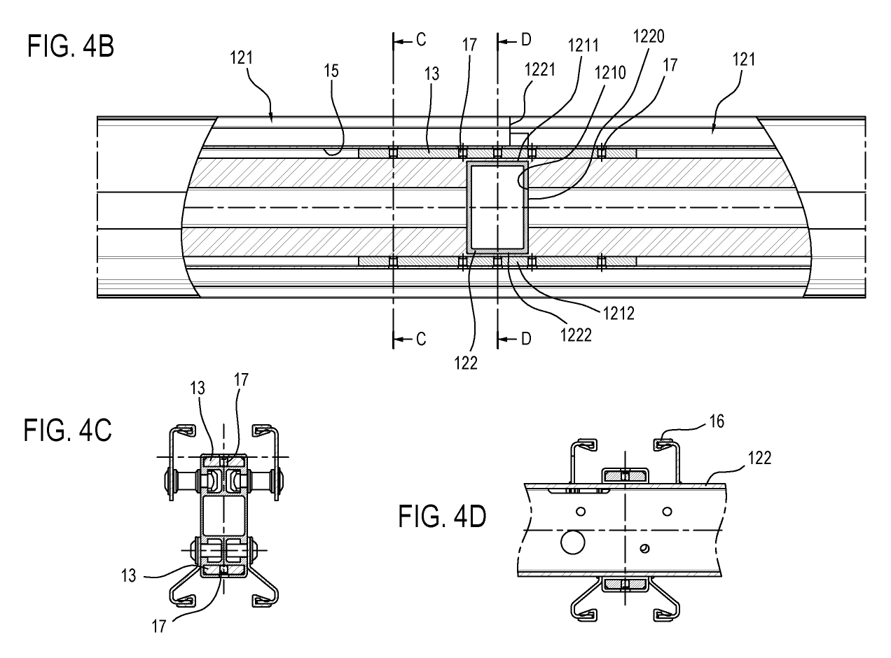

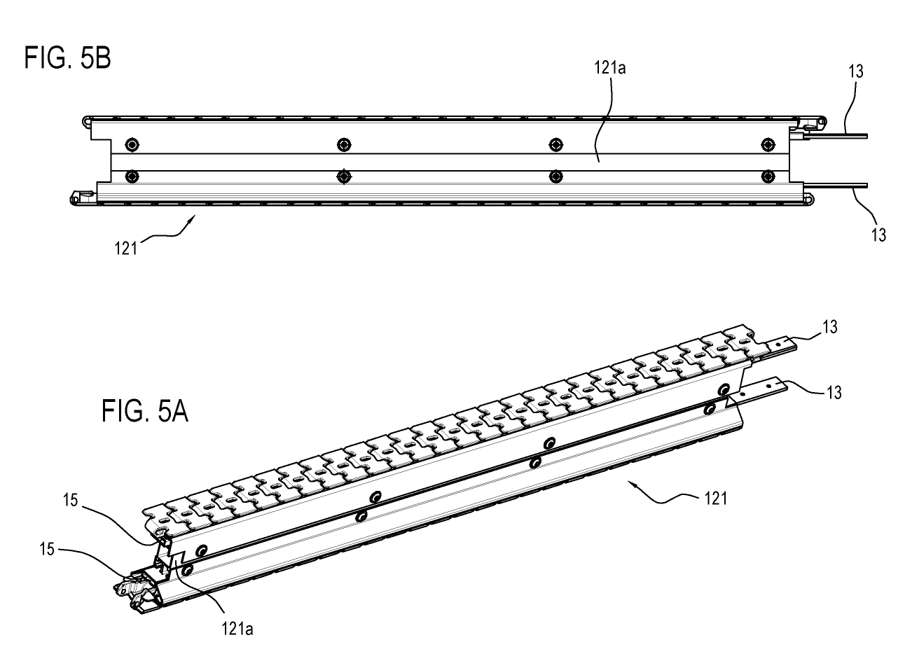

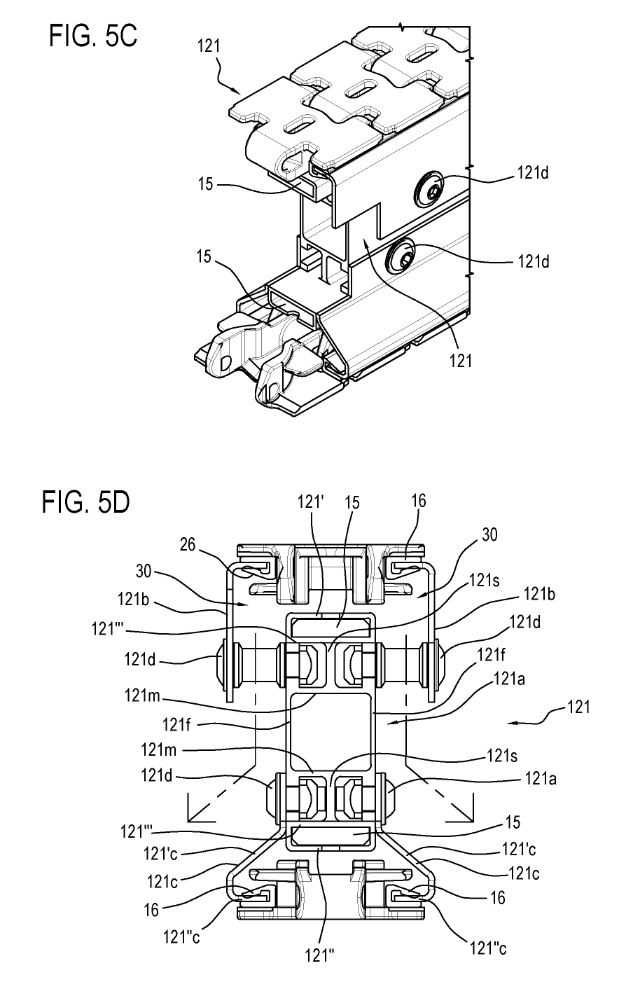

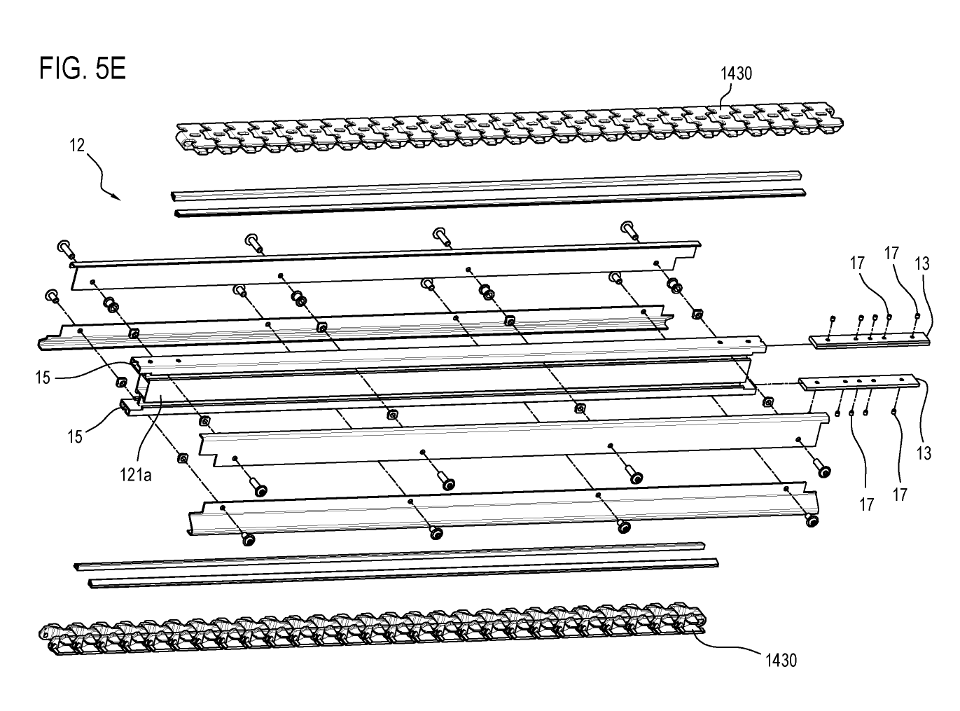

Advantageously, as may be inferred in particular from FIGS. 4A to 5E, there are means 13, 15 for mutual connection between corresponding adjacent modules or between longitudinal supporting elements longitudinally adjacent to each other or along the direction of extension of the conveying apparatus.

More specifically, the mutual connecting means 13, 15 are in the form of means which are designed to transmit between the modules, or between the corresponding longitudinal supporting elements 121, a respective and suitable bending stress.

Advantageously, the connecting means are in the form of mutually engageable means, in particular by movement along a longitudinal direction or along the direction of extension of the apparatus.

As illustrated, advantageously, the mutual connecting means 13 or 15 are provided at a respective end of the module, or of the longitudinal supporting element, in particular at both the opposite ends of the respective module, or longitudinal supporting element.

Advantageously, the mutual connecting means comprise respective protruding means 13, in particular protruding in a cantilever fashion from the respective end of the respective module, or longitudinal supporting element 121, which are designed to be inserted into corresponding recess means 15, which are provided at the corresponding end of the module or corresponding or adjacent longitudinal supporting element.

Advantageously, at the respective end of the module or longitudinal supporting element 121, there are first and second mutual connecting means 13, 13 or 15, 15 which are perpendicularly spaced from each other. As may be inferred in particular with reference to FIG. 4E, there are advantageous means for locking the mutual connecting means in the coupled position. The means for locking in a coupled position the mutual connecting means comprise respective grub screws or screws 17, which are inserted in corresponding holes 17′ provided in the body of the longitudinal supporting element 13′ provided in the respective protruding element, in particular a metal bar, 13, which are designed to retain in position the protruding means or element 13 inserted in corresponding recesses 15 of the adjacent module or longitudinal supporting element to be connected.

Advantageously, as illustrated, the corresponding transversal supporting element is interposed perpendicularly between the first and second mutual connecting means 13, 13 and 15, 15, which are perpendicularly spaced from each other.

Advantageously, the mutual connecting means between corresponding adjacent modules, or between respective longitudinal supporting elements 121, are provided by the same longitudinal supporting elements 121, which, in particular define a respective shaped end which is designed to form a respective seat for receiving the transversal element 122, which in particular mates with, or is shaped with, the profile of the respective side or lateral portion of the transversal supporting element 122.

More specifically, the shape of the receiving seat is such that it provides support by the transversal element 122 to the longitudinal elements 121 which are mutually connected.

More specifically, the respective longitudinal supporting element 121 comprises a front end face 1210 for engaging against an opposite and corresponding lateral face 1220 of the transversal supporting element 122, from which extends, longitudinally or along the direction of extension of the apparatus, a respective upper portion 1211 of the longitudinal supporting element 121, which is designed to engage the upper face 1221 of the transversal supporting element 122, and from which extends, longitudinally or along the direction of extension of the apparatus, a respective lower portion 1212 of the longitudinal supporting element 121, which is designed to engage the lower face 1222 of the transversal supporting element 122.

As may be inferred, also with reference to FIGS. 5A to 5E, the respective longitudinal supporting element 121 comprises an elongate supporting body 121a, which extends longitudinally or along the direction of extension of the apparatus or module, or also according to a curvilinear or circumferential direction.

As illustrated, the elongate supporting body 121a is in the form of a body the transversal cross section of which is more extended perpendicularly to define a corresponding section with a greater bending resistance perpendicularly to the plane of the extension or conveying of the conveyor. Moreover, the elongate supporting body 121a is in the form of a body having an outer profile usually quadrangular, in particular generally rectangular.

As illustrated, the means for mutual connection between the elongate elements, or the modules, are structurally fixed, or connected, to the elongate supporting body 121a, which defines, or has, in particular respective recesses 15, 15, especially at the upper and lower perpendicular end of the elongate supporting body 121a.

As illustrated, the respective longitudinal recess 15, upper or lower, which is designed to define corresponding means for mutual connection between corresponding longitudinal supporting elements or between adjacent modules, is delimited by a corresponding end or outer wall, respectively upper and lower 121′ or 121″ of the elongate supporting body, and by corresponding inner horizontal walls 121′″ thereof.

As illustrated, from the respective inner horizontal wall 121′″, a corresponding perpendicular partition 121s extends, which delimits corresponding longitudinal recesses for receiving corresponding enlarged ends of the pins for attaching the supporting elements of the guides of the conveyor belt, as will be described in more detail below.

As illustrated, the elongate supporting body 121a also has respective horizontal walls 121m, perpendicularly spaced and each located inwards relative to the corresponding inner horizontal wall 121′″, the horizontal walls 121m delimiting a large central recess portion of the elongate supporting body 121a, and from which horizontal walls 121m extends the respective intermediate partition 121s.

The numerals 121f, 121f denote respective vertical, or perpendicular, side walls of the elongate supporting body 121a.

Advantageously, the respective longitudinal supporting element 121 has respective means 121b, 121c for supporting the guide means 16 of the conveyor belt.

More specifically, there are means 121b for supporting an upper stretch of the guide means of the respective conveyor belt.

More specifically, the means for supporting the upper stretch of the guide means of the conveyor belt comprise first and a second transversally opposite supporting elements 121b, 121b for respective profiles 16, 16, preferably made of plastic material or other material, for guiding the product on the positive or upper branch of the conveyor belt.

As illustrated, advantageously, the first and second supporting elements 121b, 121b of the upper guide means extend perpendicularly beyond the elongate supporting body 121a, and are advantageously fixed to the elongate supporting body 121a, in particular being fixed to the corresponding side wall 121f of the elongate supporting body 121a, especially being positioned in condition transversally spaced from the side wall 121f. In this way, a free falling space is defined for the dust or waste from the transport plane of the product.

Advantageously, the respective supporting element 121b, 121b of corresponding upper guide means of the conveyor belt is, preferably, in the form of a corresponding shaped sheet, preferably made of sheet metal, and preferably comprises an upper portion 121′b defining a lower part for joining to the elongate supporting body 121a, and from which perpendicular portion extends, in particular folded at right-angles, a corresponding upper portion 121″b for engaging or for inserting of a corresponding guide profile 16.

Advantageously, means 121c are provided for supporting the guide means 16 of the conveyor belt, which support a lower stretch of the guide means of the conveyor belt.

More specifically, the means for supporting the lower stretch of the guide means of the conveyor belt comprise first and second transversally opposite supporting elements 121c, 121c of respective profiles 16, 16 for guiding the conveyor belt.

More specifically, as illustrated, advantageously, the first and second supporting elements 121c and 121c extend downwardly beyond the elongate supporting body 121a.

As illustrated, advantageously, the first and second supporting elements 121c, 121c of the lower guide means of the conveyor belt are fixed to the elongate supporting body 121a, in particular being fixed to the corresponding side wall 121f of the elongate supporting body 121a, especially being in contact with the side wall 121f thereof.

The respective supporting element 121c, 121c of corresponding lower guide means of the conveyor belt comprises a respective portion 121′c, which extends in an oblique and diverging fashion, and which in particular defines means for diverting or sliding downwards of the waste and/or dust falling from the conveying apparatus.

The respective supporting element 121c, 121c of corresponding lower guide means of the conveyor belt also comprise a lower portion 121″c, folded at right-angles, for insertion of a corresponding guide profile 16, which extends from the oblique portion 121′, from which also extends above, or at the end opposite that for insertion of the guide profile 16, a corresponding perpendicular portion 121′″c for coupling to the elongate supporting body 121a.

The supporting elements 121c, 121c are also advantageously made of corresponding shaped sheet, in particular shaped metal sheet.

Advantageously, the supporting elements 121b, 121c of the guide means of the conveyor belt are fixed to the corresponding elongate supporting body 121a through corresponding coupling pins 121d, which are longitudinally spaced from each other.

In practice, advantageously, these longitudinal supporting elements 121 have a structure which is open below which allows an easy falling of dust and waste tend towards the ground, thus not soiling in a unpleasant and harmful fashion the conveyor means and the relative supporting and drive means.

Advantageously, these longitudinal supporting elements 121 may therefore be made of metal sheet, in particular shaped, achieving a significant cost advantage.

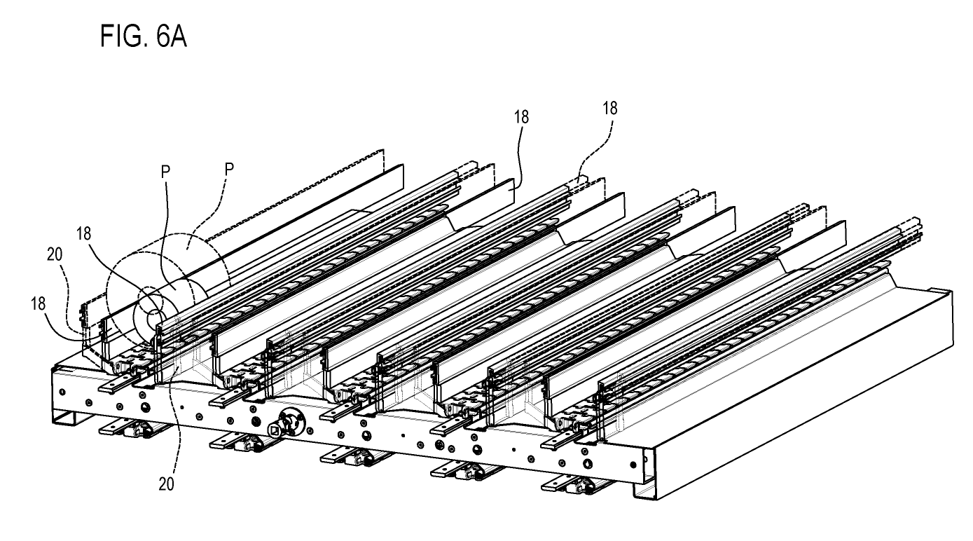

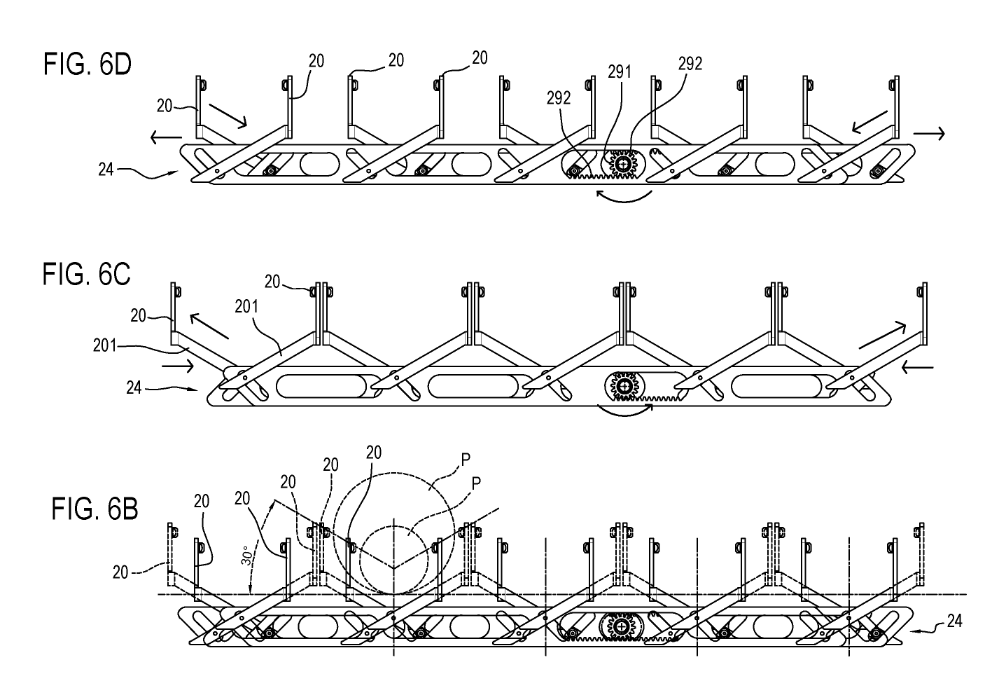

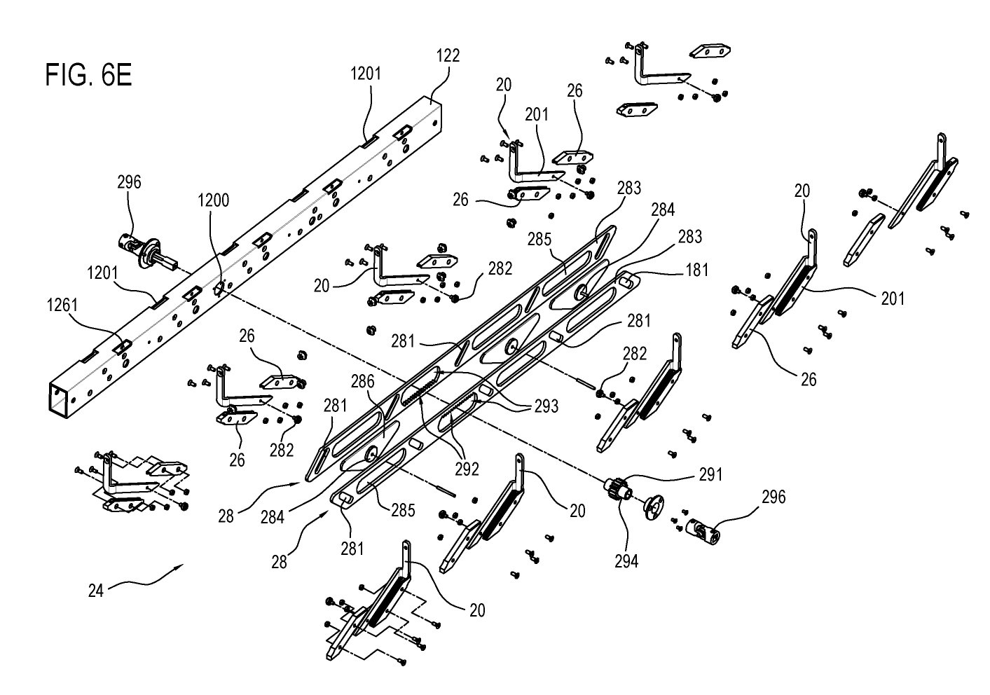

As illustrated, in particular in FIGS. 6A to 6E, the conveying apparatus also comprises means 18 for guiding the product on the means 16 for conveying the product P, in particular on the respective conveyor belt 16, which in particular define respective component means of the corresponding module of the conveying apparatus.

More specifically, the means for guiding the product P on the respective conveyor belt 143 comprise corresponding intermediate first and second longitudinal elements 18, 18 for sliding of the product P, the first and second longitudinal elements 18, 18 being transversally spaced from each other to define a respective track or transversal distance for passage of the product conveyed, defining, in practice, the transversal space which is available for the passage or feeding of the product.

For this purpose, the conveying means also comprise means 20 for supporting the means 18 for guiding the product on the means 16 for conveying the product P, in particular on the respective conveyor belt 16, which, in particular define respective component means of the corresponding module of the conveying apparatus.

More specifically, the support means of the guide means of the product on the respective conveyor belt 143 comprise corresponding arm means 20, 20, supporting a respective longitudinal element for guiding the product 18, 18, and which are longitudinally spaced apart from each other along the direction of extension apparatus and/or module.

Advantageously, the apparatus comprises means 24 for adjusting the track or transversal distance between the means for guiding the product 18 on the transport means, in particular on the respective conveyor belt, and in particular defining respective component means of the corresponding module of the conveying apparatus.

Advantageously, the means 24 for adjusting the track or transversal distance of the product guide elements 18 on the respective conveyor belt operate on the arm means 20, for supporting the respective product guide 18.

As illustrated, advantageously, the means 18, 18 for guiding the product on the means for conveying the product, in particular on the conveying belt, and/or the means 20, 20 for supporting the means for guiding the product, and/or the means 24 for adjusting the track or transversal distance of the guide means of the product, are supported by a corresponding transversal supporting element 121 of the conveying apparatus or of the respective module of the conveying apparatus.

Advantageously, as illustrated, the transversal support 121 is in the form of a body defining a compartment, in particular a substantially closed inner compartment, for housing the means 24 of adjusting the track of the means 18, 18 for guiding the product.

As may be inferred in particular from FIGS. 6A to 6E, the means for adjusting the track or transversal distance between the guide means of the product 18, 18 on the transport means comprise means for moving towards and away from each other the first and second longitudinal product guide elements 18, 18 on the respective conveyor belt, in particular a plurality of first and second longitudinal guide elements 18, 18 of the product at a respective plurality of conveyor belts of the product 143.

Advantageously, the means for adjusting the track or transversal distance between the guide means of the product on the transport means comprise means for lowering and lifting the first and second longitudinal guide elements 18, 18 on the respective conveyor belt, in particular a plurality of first and second longitudinal guide elements 18, 18 of the product at a respective plurality of conveyor belts of the product 143.

Advantageously, as illustrated, the means for moving towards and away from each other and/or lowering and lifting the first and second product guide elements 18, 18 comprise means 26 define a corresponding trajectory for corresponding means, in particular for the arm means 20, 20 supporting the first and second guide elements 18, 18.

In this way, it is possible adapt the product guides to the specific dimensions of the product conveyed, more specifically, advantageously, keeping the sliding and guide elements 18, 18 substantially at the half way line of the side of the product conveyed.

More specifically, advantageously, the means defining a corresponding trajectory for the respective guide element of the product 18 are in the form of corresponding runner means 26 for the sliding of a corresponding lower portion, in particular inclined, or oblique, 201 of the arm 20 supporting the respective guide element 18.

Advantageously, the runner means 26 extend in a linear and inclined fashion, according to a respective angle relative to the horizontal, more specifically, according to an angle which is equal, or substantially equal, to 30°.

Advantageously, the means for moving towards and away from each other and/or lowering and lifting the first and second product guide elements 18, 18 comprise means 28 for moving the arm means 20, 20 supporting the first and second guide elements 18, 18 along the means 26 defining a corresponding trajectory.

Advantageously, the means 28 for moving the arm means 20, 20 for supporting the elongate guide elements 18, 18 along the means 26 defining a corresponding trajectory are in the form of cam means 281, which are designed to move a corresponding slider element, in particular a roller 282, preferably provided at the lower end of the respective arm 20 especially at the lower end of an inclined extension 201 of the arm 20.

Advantageously, the cam means 281, for movement of the respective supporting arms of the guide elements of the product are supported on corresponding movable means 283.

Advantageously, the movable means 283 supporting the cam means 281 comprise at least a corresponding movable body 283 which defines one or a plurality of cam profiles 281 for corresponding arms 20 supporting a respective longitudinal element for guiding the product 18.

Advantageously, it comprises a first and a second movable body 283, 283, each having respective cam means 281, 281, respectively for moving a corresponding first guide element of the product 18 or a corresponding second guide element of the product 18, that is to say, a plurality of first guide elements of the product 18 or a plurality of second guide elements of the product 18.

Advantageously, the respective cam profile 281 is defined by a corresponding elongate slot, in particular linear and oblique, which is made in the respective movable body 283.

Advantageously, the first and second movable bodies 283, 283 supporting respective cam means 281 are moved, in particular transversely, according to opposite directions.

Advantageously, there are means for guiding the movement of respective movable body 283 which carries the cam means 281, in particular of the first and second movable bodies 283, 283, the guide means being in particular in the form of corresponding pins 284 for insertion in corresponding elongate slots 285, in particular elongate transversely, or horizontally, the slots 285 being provided in the movable body 283.

Advantageously, the first and the second movable body 283, 283 are longitudinally interposed by a corresponding body, or plate, 286 for engaging the movable bodies 283, 283 and for supporting corresponding and opposite pins 284 for guiding the respective movable body 283.

As illustrated, the respective movable body carries cam means 283 and is advantageously in the form of a respective shaped metal sheet.

Advantageously, the runner means 26 are angled in such a way, or with an angle, opposite, with reference to the vertical, with respect to the corresponding cam means 281.

Advantageously, the runner means 26 are integral with the transversal supporting element, or with the containing body, 122.

Advantageously, the means for adjusting the track or transversal distance between the means for guiding the product on the transport means comprising the respective drive means 29, in particular comprising a corresponding toothed sprocket 291 which engages corresponding rack means 292, 292 integral with the respective movable body 283, 283.

Further, the rack means, 292, 292 are made in a corresponding elongate slot, in particular transversal, of the respective movable body 283, 283, in which is inserted the same toothed sprocket 291. More specifically, there is a first rack on a first movable body 283, which is positioned below, and a second rack on a second movable body 283, which is positioned above, so that with the rotation of the toothed sprocket 221 the movable bodies 283, 283 are moved in opposite directions, respectively towards and lowering the guide elements the product 18, 18 and moving away and lifting of the guide elements the product 18, 18.

In practice, the first and second movable bodies 283, 283, in particular aligned according to the direction of extension of the apparatus and parallel to each other, which carry the cam means, are moved in opposite transversal directions, towards and away from each other, to provide, respectively, the moving towards and simultaneous lowering of the guide elements of the product and the moving away and simultaneous lifting of the guide elements of the product.

Advantageously, the drive means 29 comprise a shaft 294 which carries the toothed sprocket 291 and which extends, through corresponding longitudinal hole means 1200 made in the corresponding perpendicular wall, front or rear, of the transversal supporting element, or containing body, 122, outside the transversal supporting element, or containing body, 122.

Advantageously, the transversal supporting element, or containing body, 122 comprises corresponding hole means perpendicularly open 1201, which are made in the corresponding upper wall of the transversal element, or containing body, 122 for allowing the extension outside the arms carrying the longitudinal guide elements of the product.

More specifically, the drive means 29 comprise means for transmitting motion to the respective drive wheel, preferably comprising respective transmission shafts 295, each connected to the toothed sprocket 291 or to the respective supporting shaft 294 using corresponding cardanic joints 296.

In this way, it is possible for the movement for opening and closing of the guides 18, 18 for the product transported to be performed automatically or, in any case, in a centralised manner for the entire conveying apparatus or for a considerable part of the conveying apparatus, operating at predetermined points of the conveying apparatus.

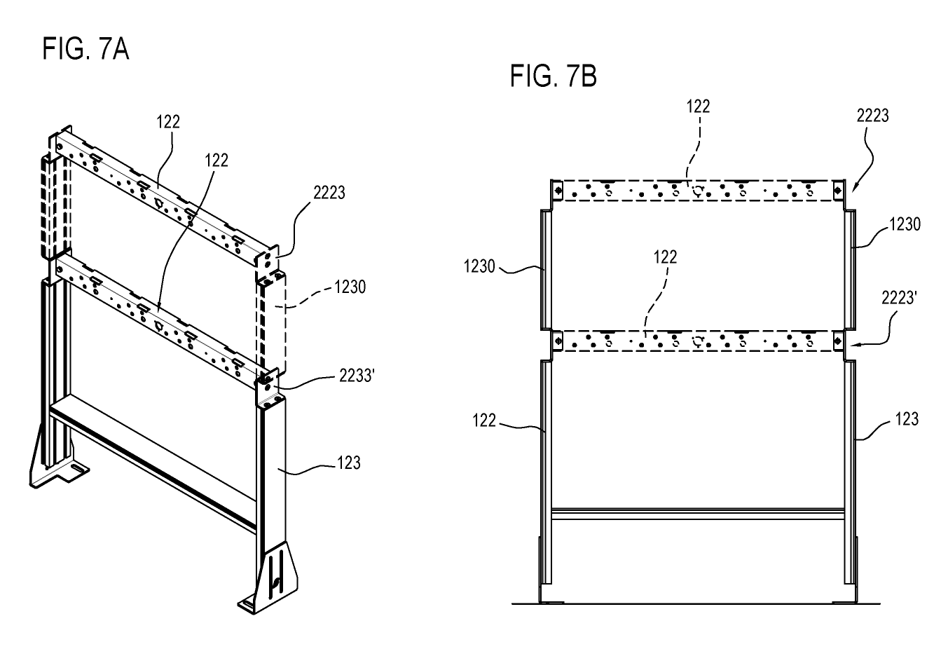

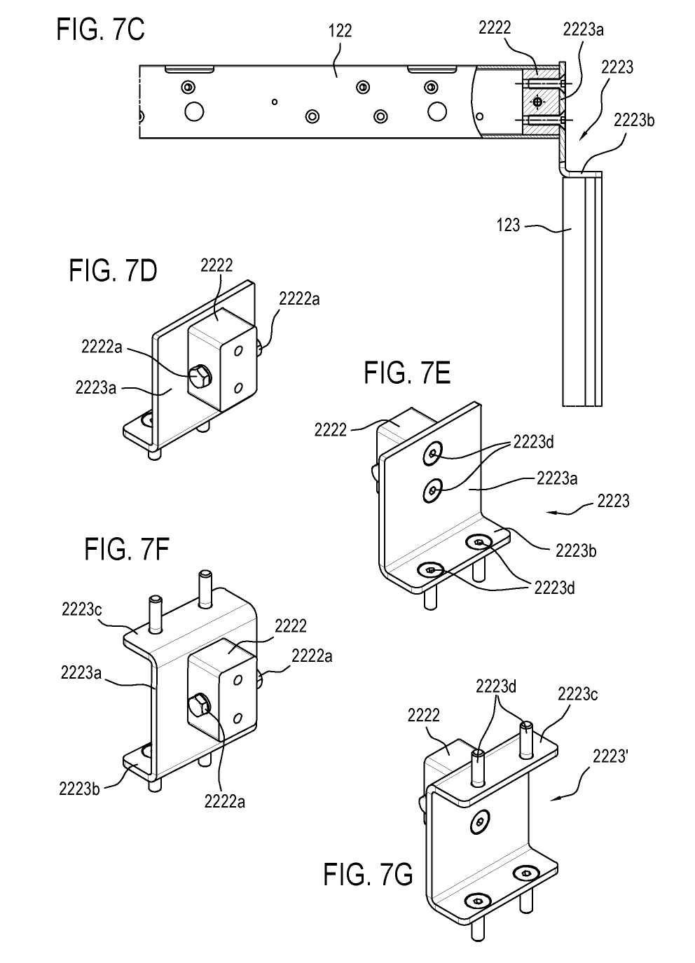

As may be inferred, also with reference to FIGS. 7A to 7G, means 2223, 2223′ are advantageously provided, in particular defining respective component means of the respective module, for coupling the supporting means, or frame, 121, 122 along the plane of conveying the product and the respective perpendicular supporting means 123, which are in particular provided between the corresponding transversal supporting elements 122 and the same perpendicular supporting means 123.

The respective coupling means 2223, 2223′ are, in particular, in the form of a corresponding bracket element 2223a for engaging and coupling to supporting means in the conveying plane of the product and a second portion, or transversal portion, 2223b for engaging and coupling to perpendicular supporting means 123, the second engagement and coupling portion 2223b extending to define a respective angle, in particular an angle of 90°, relative to the first engagement and coupling portion 2223a.

This coupling element formed generally with an “L” shape, is in particular used to connect a respective perpendicular supporting element 123 to the supporting means, or frame, in the conveying plane, that is, for connecting a second perpendicular supporting element 1230, which is positioned above and is designed to support a corresponding upper conveying plane, as illustrated in FIGS. 7A and 7B.

Alternatively, in the case of extending the lower uprights 123, which support a respective conveying plane, with further upper perpendicular supporting elements 1230, for supporting an upper conveying plane, use is made of a corresponding bracket element 2223′, which has, advantageously, a third portion, that is, a second transversal portion, 2223c for engaging and coupling corresponding perpendicular upper supporting means 1230, the third portion 2223c extending to define an angle, in particular an angle of 90°, relative to the first engagement and coupling portion 2223a, in particular extending from the end of the latter which is opposite the end from which extends the second portion, or first transversal portion, 2223b for coupling, in particular to define a corresponding bracket element which has a general “C” shape.

In this way, both in the shape of an “L” and in the shape of a “C”, advantageously, the coupling means 2223, 2223′ define means for passage of the corresponding continuous elements, in particular in the form of ducts, cables and/or electrical and/or pneumatic wiring or the like.

In practice, the bracket element 2223, 2223′ has a first portion, or perpendicular portion 2223a, at the rear, or laterally, defining a space for the passage or extension for a corresponding lateral zone for housing the continuous elements.

Moreover, the space for the passage of the continuous elements is also delimited towards the rear, that is, above and/or below, of the respective transversal portion 2223b or 2223c of the respective bracket element 2223, 2223′.

In practice, the respective transversal portion 2223b and/or 2223c is at right angles to the perpendicular engagement and coupling portion 2223a, so as to define a corresponding channel for passage of the continuous elements of the apparatus.

Advantageously, the coupling means 2223, 2223′ comprise a respective block 2222, for inserting in the corresponding supporting means extending along the conveying plane of the product, that is, in particular, inserting in the corresponding transversal supporting element 122, preferably through a corresponding open end thereof.

As illustrated, advantageously, the inserting block 2222 extends forwards from the respective perpendicular portion 2223a of the bracket element 2223, 2223′, and in particular comprises opposite lateral holes for insertion of corresponding screws 2222a for coupling to the transversal supporting element 122, in particular through corresponding holes made in the sidewalls of this at the coupling end.

As illustrated, there are advantageously corresponding screws 2223d for fastening portions of the bracket element, or coupling bracket, to the perpendicular supporting means 123, 1230 and/or to the respective inserting block 2222.

As may be inferred in particular from FIG. 5D, means 30 are advantageously provided for removal of waste and/or dust.

More specifically, means are provided 30 for removing waste and/or dust from the means of transport of the product, in particular from the respective conveyor belt.

Advantageously, the means 30 for removing waste and/or dust are in the form of means for blowing a corresponding jet of air.

Advantageously, the means 30 for removal of waste and/or dust act, that is, blow, on the upper branch of the conveyor belt, in particular on the lower part of the upper branch of the conveyor belt.

Advantageously, the means for removing waste and/or dust comprise first and second removal means 30, 30, in particular in the form of corresponding nozzles, which act on opposite longitudinal sides of the respective conveyor belt, in particular blowing towards the centre of the longitudinal supporting element 121.

Advantageously, the means 30 for removing waste and/or dust are fixed to the longitudinal supporting element 121 of the respective conveyor belt.

More specifically, as illustrated, the means 30 for removing waste and/or dust are fixed to the respective element, or plate, 121b, 121b for supporting the respective guide element 16, 16 of the upper branch of the conveyor belt, in particular perpendicularly below the same guide element 16, 16.

As illustrated, in particular in FIGS. 1, 3C and 3D, the apparatus also comprises covering means 32, preferably extending in the plane which conveys the product, in particular extending laterally and preferably in the space which is present between corresponding longitudinal supporting elements 121, which are transversally spaced from each other and preferably extend parallel or equidistant to each other. The covering means 32, in particular, define respective component means of the respective module.

Advantageously, the covering means 32 are defined by corresponding shaped plates which are supported by the longitudinal supporting elements 121, the covering means, or corresponding plates, 32 being fixed to the respective side wall of the corresponding longitudinal supporting element 121.

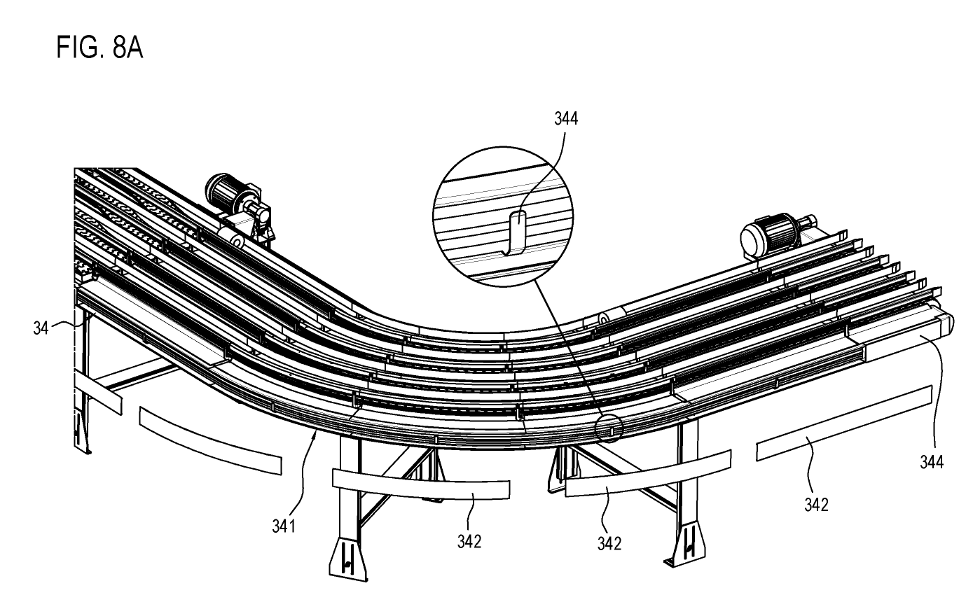

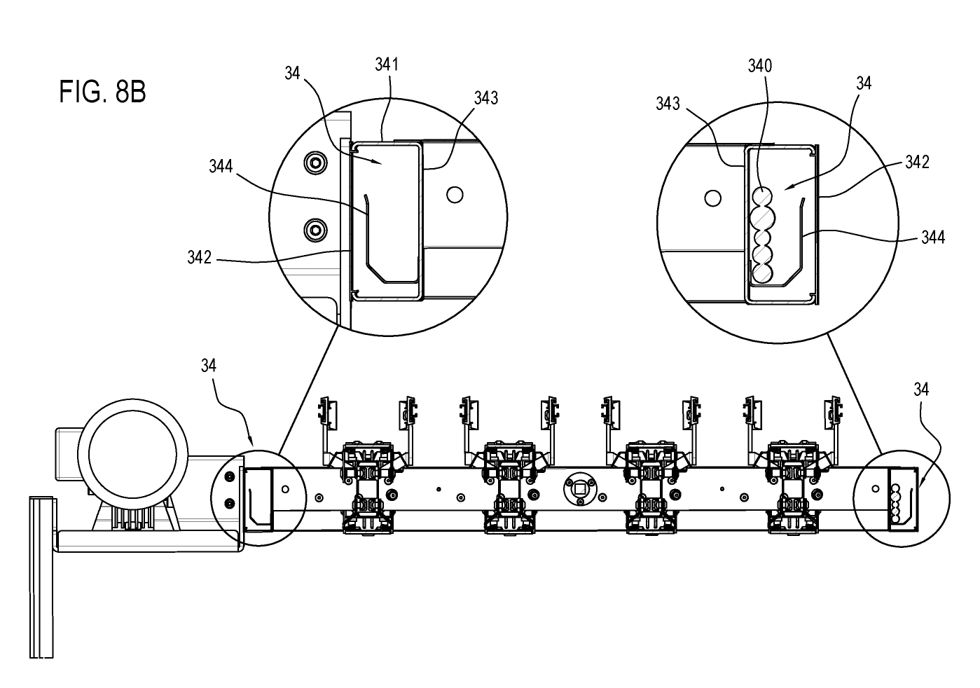

As may be inferred in particular from FIGS. 3A, 3D and 8A, 8B, means are advantageously provided 34 for housing corresponding continuous elements 340, in particular in the form ducts, cables, electrical and/or pneumatic wiring or the like, which extend along the conveying apparatus. The means 34 for housing the continuous elements 340 which extend along the conveying apparatus define respective component means of the respective module.

Advantageously, the means 34 for housing the corresponding continuous elements 340 extend laterally to the respective conveying plane of the product, in particular on both the lateral flanks of the respective plane for conveying the product.

Advantageously, the housing means 34 for corresponding continuous elements 340 are supported by the respective transversal supporting element 122, in particular extending between, and being supported by, longitudinally spaced transversal supporting elements 122.

Further advantageously, the housing means 34 for the continuous corresponding elements 340 define a respective elongate channel 341, in particular having a respective cover 342, which can be engaged and disengaged with the body 343 of the channel 341. The cover being preferably provided on the side wall of the channel, that is to say, on the side which is transversally facing outwards from the conveying apparatus. Advantageously, the means 34 for housing the corresponding continuous elements 340 comprise, internally, that is, inside the space for housing the respective continuous elements 340, tab means for retaining the continuous elements.

The retaining tab means, labelled 344, extend from the rear wall, or inner side wall, of the channel, extending upwards to define a respective zone for retaining continuous elements which is included between the tab and the rear or inner side wall of the channel.

More specifically, as may be inferred, there are a plurality of tabs 344 for retaining the continuous elongate elements, which are longitudinally spaced from each other along the longitudinal direction of extension of the conveying apparatus.

Advantageously, the means, or channel, for housing the continuous elements may comprise suitable openings for the falling of dust or waste, which are the source of potential fast propagation of flames in the case of fire.

As may be well inferred with reference to FIGS. A to 9E, means 50 are advantageously provided for lifting, or perpendicular extension of, the conveyor belt, in particular a corresponding end portion 121e of the supporting means, in particular longitudinal, 121 which carry the respective conveyor belt.

Advantageously, the lifting means comprise an articulated joint 50, from which extends a corresponding end portion 121e of the supporting means, in particular longitudinal, 121 which carry the respective conveyor belt.

Advantageously, the articulated joint 50 allows the rotation of the end portion 121e relative to the respective longitudinal supporting means or element 121 by a predetermined angle, for example by an angle equal to 30°.

Advantageously, the articulated joint 50 allows the rotation of the end portion 121e of the supporting means 121 relative an axis transversal to the longitudinal direction of conveying or extension of the conveying apparatus.

For this purpose, there are means for stopping the rotation of the end portion 121e in the lifted position, which comprise opposite surfaces 121 “and, at the rear end of the end portion 121e and 121” at the longitudinal end of the longitudinal supporting means 121, which are designed to engage with each other, in the lifted, or perpendicularly extended, position of the end portion 121e.

Advantageously, corresponding means can be provided for lifting the corresponding end portion 121e relative to the supporting means 121, wherein the lifting means could comprise an advantageous actuator for lifting or perpendicular extension of the end portion 121e.

Equally advantageously, there may be means for retaining the corresponding end portion 121e in the raised condition, or extended perpendicularly, in such a way as to allow an easy and secure execution of the maintenance and/or cleaning operations of the conveying apparatus.

Further advantageously, there are means 51, 52 for retaining the corresponding end portion 121e in the transport condition, or in the condition aligned with the supporting means, in particular longitudinal, 121 of the respective conveyor belt.

Advantageously, the means 51, 52 for retaining the corresponding end portion 121e in the conveying condition are in the form of engaging means 51, 52 which can be inserted in a corresponding recess, in particular circular, 53, 54, the recess being provided at the end of the end portion 121e, in particular being made inside respective wheel means for drive 40 or return 41, in particular at the corresponding hollow, or tubular, shaft which supports the wheel.

In practice, the means 51, 52 for retaining the corresponding end portion 121e in the conveying condition are in the form of engaging means 51, 52 which can be inserted into a corresponding recess, specifically circular, 53, 54, which is in correspondence with a corresponding end head, in particular which can be disengaged from the end portion 121e, which carries the wheel means 40, 41.

Advantageously, the insertable engaging means 51, 52 are designed to be inserted, for retaining the end portion 121, in a parallel and coaxial cavity, in particular circular, which is defined by the corresponding joint 50 of an end portion parallel and alongside 121e, which extends, like the end portion to be lifted 121e with longitudinal profile and general shape of an elongate “S” for defining corresponding means for transferring the product between corresponding longitudinal portions of the conveying apparatus.

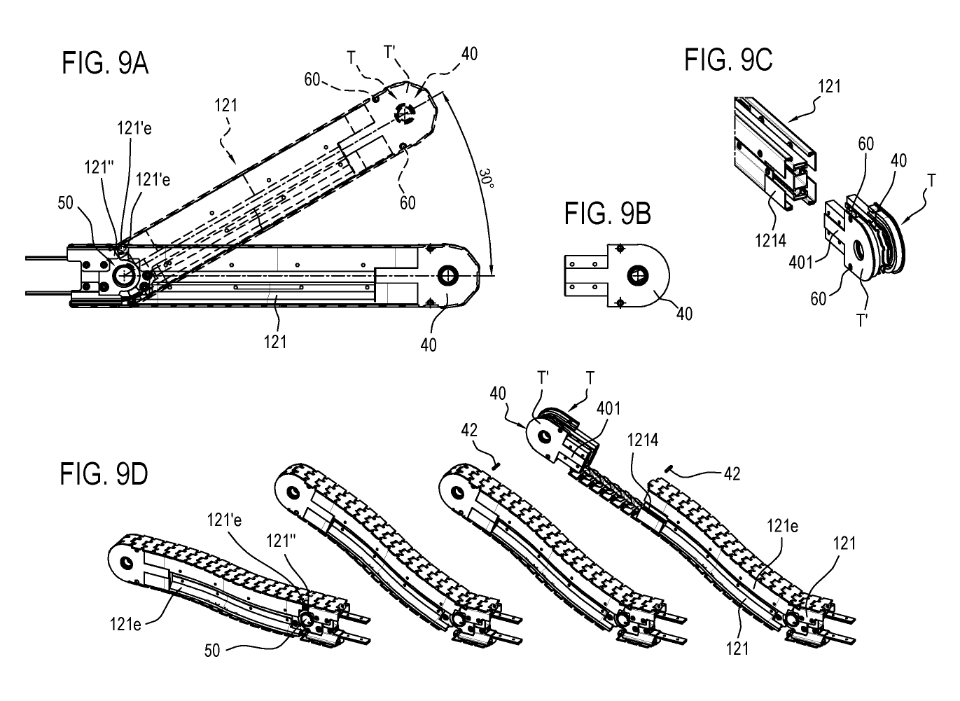

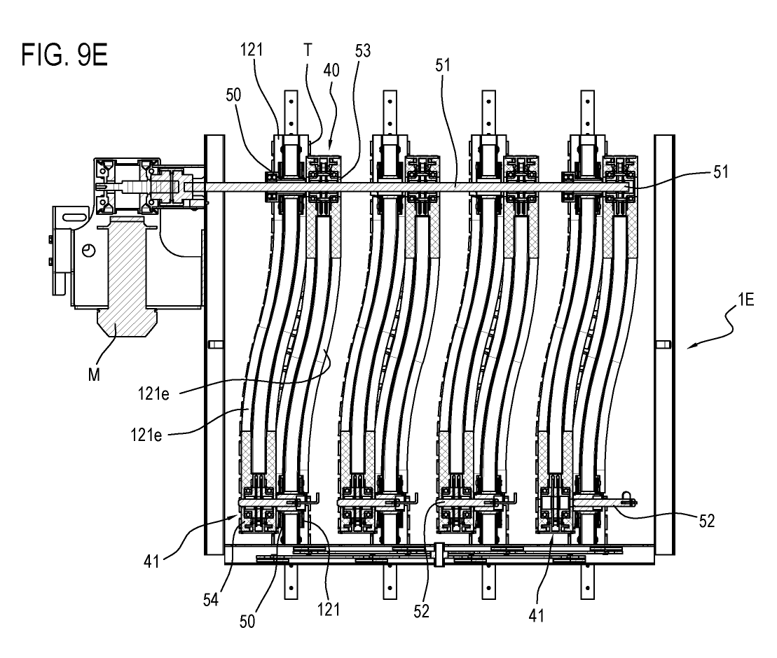

In practice, FIG. 9E illustrates a module for transferring the product 1E, which thanks to suitable product guides which extend in a rectilinear fashion keeps the product in the aligned or longitudinal feed condition and facilitates the passage by the conveying means upstream and by the conveying means downstream, that is, between the corresponding end portions 121e, 121e parallel side by side, respectively front and rear of corresponding longitudinal portions of the conveying apparatus.

Advantageously, the means of retaining the corresponding end portion 121e in the conveying condition, or aligned with the corresponding longitudinal supporting means 121, comprise a transversal shaft 51 for transmitting the motion by corresponding motor means M to the respective drive wheel means 40, the shaft 51 being, advantageously, removable, by a transversal movement, to free the respective end portion 121e of the corresponding supporting means of the conveyor belt.

Further advantageously, the means for retaining corresponding end portion 121e in the conveying condition aligned with the respective supporting means 121, comprise a corresponding inserting pin 52 coaxial with the respective end of the end portion 121e, from which it is advantageously removable to free the latter and allow the lifting or perpendicular extension of the latter in view of a convenient cleaning maintenance.

Advantageously, the apparatus comprises drive and/or return means 40, 41 for the means for conveying the product, in particular of the respective conveyor belt, especially defining respective component means of the respective module, which, in particular, reverse the path of the transport means between an active branch for feeding the product, in particular upper, and a corresponding return branch, active or lower, the drive and/or return means comprising corresponding roller means, especially in the form of toothed wheel drive means 40, which have respective means, or teeth, for engagement with the links of the respective conveyor belt, that is, in the form of simple drive wheels 41.

Advantageously, the drive and/or return means 40, 41 comprise a respective end head T supporting corresponding drive or return roller means, the head T being supported by corresponding means, in particular longitudinal, 121 for supporting the respective conveyor belt, in particular, as mentioned above, from a respective movable or liftable end portion 121e of the longitudinal supporting means 121 of the corresponding conveyor belt.

Advantageously, the means 40, 41 for drive and/or return of the conveyor belt, or the respective head T, can be engaged and disengaged with/from the supporting means 121 of the respective conveyor belt.

For this reason, the respective drive or return wheel, in particular after lifting the corresponding end portion 121e of the conveyor belt, can be removed, easily, together with the corresponding supporting head T from the supporting means of the conveyor belt, to allow a new one to be installed, carried by a corresponding head T, on the supporting means, especially when it is necessary to replace or carry out maintenance of the wheel 40 or 41, because it is no longer functions or operates perfectly.

More specifically, advantageously, the means 40, 41 for drive or return, that is, the respective head T for supporting the corresponding drive and/or return wheel, can be engaged and disengaged with the supporting means 121 of the conveyor belt.

Advantageously, there are respective guide means 401, 1214, which can be mutually inserted, respectively positioned on the drive and/or return means 40, 41, or on the respective head T, and on the supporting means 121 of the conveyor belt, in particular at the longitudinal end of the supporting means 121.

In practice, the drive and/or return means 40, 41, or the respective head T, comprise a respective longitudinal guide profile 401, which can be inserted in a corresponding guide counter-profile 1214, also longitudinal, provided on the transport means 121 of the conveyor belt, that is, on the longitudinal end of the supporting means 121 of the conveyor belt.

Advantageously, in this way, the drive and/or return means 40, 41, or the respective head T, can be engaged and disengaged with/from the respective supporting means 121 through a axial simple movement of the supporting means, in particular longitudinal, 121 of the conveyor belt, that is, with an axial movement with respect to the corresponding end of the supporting means 121 to which the drive and/or return means 40, 41 are associated.

There are advantageously means for locking the drive and/or return means 40, 41, or the respective head T, to the respective supporting means 121.

The means for locking the drive and/or return means 40, 41, or the respective head T, to the respective supporting means 121, are defined by the respective conveyor belt in condition wound around the corresponding wheel means.

Advantageously, there are means 60 which allow the detachment between respective links of the conveyor belt, and the consequent opening of the conveyor belt itself.

More specifically, there are means 60 which allow the detachment between respective links of the conveyor belt, when they are positioned, in wound condition, on the guide means of the product transport means of the conveying apparatus, or of the respective module.

Advantageously, the means 60 which allow the detachment between respective links of the conveyor belt are provided on the longitudinal supporting elements 121.

More specifically, advantageously, the means 60 which allow the detachment between respective links of the conveyor belt are provided at the respective head end T for respective drive and/or return wheel means, especially of the respective sidewall T′ of the same end head T.

Advantageously, the means which allow the detachment between respective links of the conveyor belt are in the form of corresponding hole means 60 for passage of a corresponding element for engagement and disconnection of the pin 42 which joins adjacent links of the conveyor belt. Advantageously, the means which allow the detachment between respective links of the conveyor belt are in the form of a corresponding transversal hole 60 passing through the respective sidewall T′ of the longitudinal supporting element 121. More specifically, the means which allow the detachment between respective links of the conveyor belt comprise a first and a second hole 60, 60, perpendicularly spaced from each other, on opposite upper and lower branches of the respective conveyor belt, in this way allowing a greater operating freedom for the personnel.

More specifically, for removing the head T which carries the respective wheel, to be replaced or checked, use is firstly made of a corresponding tool, to remove, through the corresponding hole 60, a respective pin 42 which keeps together two adjacent links of the conveyor belt; the conveyor belt is then opened and the respective head T is removed from the supporting means 121 to advantageously replace it with a new head T, installing a corresponding wheel ready for use; it is then re-closed, assembling the conveyor belt with articulated links around the wheel which carries the new head T.

According to a different embodiment, the detachment or disengagement tool between the links of the conveyor could be directly provided, carried by the means for supporting the conveyor belt, at the means 60 which allow the detachment of the links of the conveyor to be obtained.

More specifically, as illustrated, in the transfer module 1E there are guide means for respective incoming conveying means and respective outgoing conveying means, wherein the guide means extend along respective stretches, in particular ends, which are partly placed side by side to allow the transfer of the product by infeed conveying means and outfeed conveying means.

Advantageously, a conveying apparatus or corresponding module is obtained which has a high accessibility of the product conveyed, that is, it does not have excessive dimensions for the operators who must access the product conveyed and allows an excellent viewing of the product, for example to perform a corresponding control of the product conveyed.

The invention described has evident industrial applications. It would be obvious to one skilled in the art that several changes and modifications can be made to the invention without departing from the spirit and scope of the invention, described in depth above. More specifically, one skilled in the art could easily imagine further embodiments of the invention comprising one or more of the features described herein. It will also be understood that all the details of the invention may be substituted by technically equivalent elements.

1-135. (canceled)

136. An apparatus (10) for conveying a product, the product preferably being in the form of respective articles, in particular in the form of articles of the tissue sector, preferably made of paper or other material, such as fabric or non-woven fabric, the articles being preferably in the form of rolls, packages, in particular packs or packets, or respective containers, in particular for toilet paper, kitchen paper, napkins, tissues, serviettes, towels, bed sheets, and other, or in the form of rolls of material which can be used in the kitchen, such as aluminium foil, plastic film or similar; the apparatus (10) comprising supporting means (12) for corresponding means (14) for conveying the product, in particular having one or a plurality of conveyor belts (141), especially of the type with links (142) articulated to each other, preferably through corresponding articulation pins; wherein the apparatus has a plurality of separate modules (1A, 1B, 1C, 1D, 1E, 1F, 1G), each of which is designed to define a respective conveying section or stretch or longitudinal extension of the apparatus, the respective modules can be associated with each other and comprise a plurality of component means of the conveying section or stretch which are in a pre-assembled condition on the respective module.

137. The apparatus according to claim 136, wherein the respective module (1B, 1D) is designed to define a respective section, or stretch, of the conveying apparatus which extends in a rectilinear fashion.

138. The apparatus according to claim 136, wherein the respective module (1C, 1F) is designed to define a respective section, or stretch, of the conveying apparatus which extends in a curvilinear fashion, in particular being designed to curve in the product conveying plane along a direction to the right, or being designed to curve in the conveying plane to the left, and preferably extending along the direction of extension of the apparatus for an angular stretch which is equal to 30° or equal to 45°.

139. The apparatus according to claim 136, wherein the respective module (1E) is designed to define a respective section, or stretch, of the means for transferring the product between an upstream portion and a downstream portion of the means for conveying the product.

140. The apparatus according to claim 136, wherein the respective module (1G, 1E) is designed to define a respective section, or stretch, of the conveying apparatus which defines means for driving the means of transport, in particular defining a respective end drive head (1G), that is, defining a respective drive head at a section, or stretch, for transferring the product (1E).

141. The apparatus according to claim 136, wherein the respective module (1C) is designed to define a respective section, or stretch, of the conveying apparatus which defines means for driving the means of transport, that is, which defines a respective end return head of the conveying apparatus.

142. The apparatus according to claim 136, wherein the respective modules (1A, 1B, 1C, 1D, 1E, 1F, 1G) are connectable directly to one another.

143. The apparatus according to claim 136, wherein the respective modules are connectable to each other at respective and opposite ends (E′ and/or E″) respectively upstream and/or downstream according to the direction of extension of the conveying apparatus.

144. The apparatus according to claim 136, wherein the ends (E′, E″) facing each other, of the modules connected to each another, engage one against the other.

145. The according to claim 136, wherein the respective component means of the respective module comprise a respective portion (143), in particular an upper branch and/or a lower branch (1430, 1430), of a respective conveyor belt (141).

146. The apparatus according to claim 136, wherein it comprises supporting means (12), in particular defining respective component means of the corresponding module, the supporting means comprising one or a plurality of longitudinal supporting elements (121).

147. The apparatus according to claim 146, wherein the respective longitudinal supporting element (121) is designed to support a corresponding portion (143) of a respective conveyor belt (141).

148. The apparatus according to claim 146, wherein the longitudinal supporting elements (121) are transversally spaced from each other and preferably parallel or equidistant.

149. The apparatus according to claim 146, wherein respective longitudinal supporting elements (121) extend aligned with each other, that is to say, with corresponding end portions which are side by side.

150. The apparatus according to claim 136, wherein it comprises supporting means (12), in particular defining respective component means of the corresponding module, the supporting means comprising a respective transversal supporting element (122), in particular a transversal supporting element (122), for each module, if necessary a first and a second transversal supporting element (122, 122), for each module.

151. The apparatus according to claim 150, wherein the respective transversal supporting element (122) extends at right angles to the respective longitudinal supporting element (121) or radially relative to the corresponding longitudinal supporting circumferential element.

152. The apparatus according to claim 150, wherein the respective transversal supporting element (122) extends substantially coplanar to the corresponding longitudinal supporting element (121).

153. The apparatus according to claim 150, wherein the respective transversal supporting element (122) extends between corresponding longitudinal supporting elements (121, 121) which are longitudinally aligned with each other, or aligned with each other along the direction of extension of the apparatus.

154. The apparatus according to claim 150, wherein the respective transversal supporting element (122) is at the end of the respective longitudinal supporting element (121) or of the respective module of the apparatus.

155. The apparatus according to claim 136, wherein it comprises supporting means (12), in particular defining respective component means of the corresponding module, the supporting means defining a corresponding supporting frame (121, 122) which extends to define a respective plane of extension of the conveying apparatus.

156. The apparatus according to claim 150, wherein the respective transversal supporting element (122) supports the longitudinal supporting elements (121).

157. The apparatus according to claim 150, wherein the respective transversal supporting element (122) is in the form of a tubular body, in particular with a quadrangular cross section, preferably rectangular, in particular housing inside it means for adjusting the guides of the product.

158. The apparatus according to claim 136, wherein it comprises supporting means (12), in particular defining respective component means of the corresponding module, the supporting means of the respective perpendicular supporting means (123) preferably being in the form of means or uprights resting on the ground.

159. The apparatus according to claim 158, wherein the respective transversal supporting element (122) is supported by the perpendicular supporting means (123), which are preferably fixed to the lateral ends of the respective transversal supporting element (122).

160. The apparatus according to claim 136, wherein it comprises means (16) for guiding the means of transport of the apparatus, in particular defining respective component means of the corresponding module.

161. The apparatus according to claim 160, wherein the respective means (16) for guiding the transport means of the apparatus, in particular of a corresponding module, which preferably comprise first guide means (16) for a respective outward and/or upper branch of the conveyor belt and second guide means (16) for a corresponding return and/or lower branch of the conveyor belt.

162. The apparatus according to claim 160, wherein the means (16) for guiding the transport means of the apparatus or of the module are supported by the respective longitudinal supporting element (121).

163. The apparatus according to claim 136, wherein it comprises means (13, 15) for mutual connection between corresponding adjacent modules (1A, 1B, 1C, 1D, 1E, 1F, 1G) or between respective longitudinal supporting elements (121).

164. The apparatus according to claim 163, wherein the mutual connecting means are in the form of mutually engageable means (13, 15), in particular by longitudinal movement or along the direction of extension of the apparatus.

165. The apparatus according to claim 163, wherein the mutual connecting means (13 or 15) are provided at a respective end, in particular at both the opposite ends (E′ and/or E″) of the respective module, or longitudinal supporting element.
